(19) United States
(12) Patent Application Publication
(10) Pub. No.: US 2012/0331194 A1
(43) Pub. Date: Dec. 27, 2012

(54) INTERFACE EXTENDER FOR PORTABLE ELECTRONIC DEVICES

(75) Inventor: Alex J. Crumlin, San Jose, CA (US)

(73) Assignee: APPLE INC., Cupertino, CA (US)

(21) Appl. No.: 13/167,271

(22) Filed: Jun. 23, 2011

(51) Int. Cl. G06F 13/00

(52) U.S. Cl. 710/110

(57) ABSTRACT

The disclosed embodiments provide a system that facilitates communication between components in a portable electronic device. The system includes a first hub that couples a first set of interfaces to a high-speed link and a second hub that couples a second set of interfaces to the high-speed link. The first hub may receive a communication from a first component through a first interface in the first set of interfaces and transmit the communication through the high-speed link. The second hub may receive the communication from the high-speed link and transmit the communication to a second component through a second interface in the second set of interfaces. The first and second hubs may thus reduce the number of wires required to transmit communications between the first and second sets of interfaces.

### BACKGROUND

1. Field

The present embodiments relate to interfaces in portable electronic devices. More specifically, the present embodiments relate to an interface extender that facilitates efficiently using space within a portable electronic device.

2. Related Art

Recent improvements in computing power and wireless networking technology have significantly increased the capabilities of portable electronic devices, such as laptop computers, tablet computers, portable media players, and mobile phones. Such increased capabilities are typically provided by multiple components on different printed circuit boards (PCBs). For example, a tablet computer may contain separate PCBs for processors, ports, buttons, radio and/or wireless transceivers, batteries, and/or other components in the tablet computer.

The components and/or PCBs may then be electrically connected to allow the components to implement the functionality of the portable electronic device. For example, an Inter-Integrated Circuit (I²C) bus and/or a set of general-purpose input-output (GPIO) interfaces may connect a set of peripheral components to a processor through a set of wires. The processor may then communicate with the peripheral components by transmitting signals through the wires to the peripheral components and receiving responses from the peripheral components through the wires.

However, the number of wires in a portable electronic device may increase as the functionality and/or number of components in the portable electronic device increases. For example, multiple I²C buses may be used to connect processors and/or microcontrollers that operate as bus masters to various peripheral components operating as bus slaves within a tablet computer. In turn, wires may occupy increasing amounts of space within the portable electronic device, thus reducing the space available for components in the portable electronic device and/or requiring a corresponding increase in the size of the portable electronic device.

Hence, the use of portable electronic devices may be facilitated by improving the space efficiency of interfaces for enabling communication among components in the portable electronic devices.

### SUMMARY

The disclosed embodiments provide a system that facilitates communication between components in a portable electronic device. The system includes a first hub that couples a first set of interfaces to a high-speed link and a second hub that couples a second set of interfaces to the high-speed link. The first hub may receive a communication from a first component through a first interface in the first set of interfaces and transmit the communication through the high-speed link. The second hub may receive the communication from the high-speed link and transmit the communication to a second component through a second interface in the second set of interfaces. The first and second hubs may thus reduce the number of wires required to transmit communications between the first and second sets of interfaces.

In some embodiments, transmitting the communication through the high-speed link involves encoding the communication, and receiving the communication from the high-speed link involves decoding the communication. The communication may be encoded by identifying the first interface and a transition associated with the communication, and encoding the transition and the first interface into a packet. The communication may then be decoded by obtaining the transition and the first interface from the packet, and generating the transition at the second interface.

In some embodiments, the first hub corresponds to a hub master, and the second hub corresponds to a hub slave.

In some embodiments, the hub slave is connected to one or more bus master components, and the hub master is connected to one or more bus slave components.

In some embodiments, the hub slave is configured to receive configuration information from a processor in the portable electronic device, and propagate the configuration information to the hub master.

In some embodiments, each of the hubs includes a first level shifter configured to convert a set of interface voltages from the first set of interfaces to a core voltage associated with the first hub, and a second level shifter configured to convert the core voltage to a link voltage associated with the high-speed link.

In some embodiments, the high-speed link includes a clock wire, a first data wire associated with communications from the first set of interfaces to the second set of interfaces, and a second data wire associated with communications from the second set of interfaces to the first set of interfaces.

In some embodiments, the first and/or second sets of interfaces include an Inter-Integrated Circuit (I²C) interface, a serial peripheral interface (SPI), a secure digital input output (SDIO) interface, and a general-purpose input-output (GPIO) interface.

### BRIEF DESCRIPTION OF THE FIGURES

FIG. 1 shows a schematic of a system in accordance with an embodiment.

FIG. 2 shows the connection of a hub slave and a hub master to a set of components in accordance with an embodiment.

FIG. 3 shows a set of wires and a set of interfaces associated with a hub slave and a hub master in accordance with an embodiment.

FIG. 4 shows the use of a set of voltages in a hub slave and a hub master in accordance with an embodiment.

FIG. 5 shows a flowchart illustrating the process of facilitating communication between components in a portable electronic device in accordance with an embodiment.

FIG. 6 shows a portable electronic device in accordance with an embodiment.

In the figures, like reference numerals refer to the same figure elements.

### DETAILED DESCRIPTION

The following description is presented to enable any person skilled in the art to make and use the embodiments, and is provided in the context of a particular application and its requirements. Various modifications to the disclosed embodiments will be readily apparent to those skilled in the art, and the general principles defined herein may be applied to other embodiments and applications without departing from the spirit and scope of the present disclosure. Thus, the present invention is not limited to the embodiments shown, but is to be accorded the widest scope consistent with the principles and features disclosed herein.

The data structures and code described in this detailed description are typically stored on a computer-readable storage medium, which may be any device or medium that can store code and/or data for use by a computer system. The computer-readable storage medium includes, but is not limited to, volatile memory, non-volatile memory, magnetic and optical storage devices such as disk drives, magnetic tape, CDs (compact discs), DVDs (digital versatile discs or digital video discs), or other media capable of storing code and/or data now known or later developed.

The methods and processes described in the detailed description section can be embodied as code and/or data, which can be stored in a computer-readable storage medium as described above. When a computer system reads and executes the code and/or data stored on the computer-readable storage medium, the computer system performs the methods and processes embodied as data structures and code and stored within the computer-readable storage medium.

Furthermore, methods and processes described herein can be included in hardware modules or apparatus. These modules or apparatus may include, but are not limited to, an application-specific integrated circuit (ASIC) chip, a field-programmable gate array (FPGA), a dedicated or shared processor that executes a particular software module or a piece of code at a particular time, and/or other programmable-logic devices now known or later developed. When the hardware modules or apparatus are activated, they perform the methods and processes included within them.

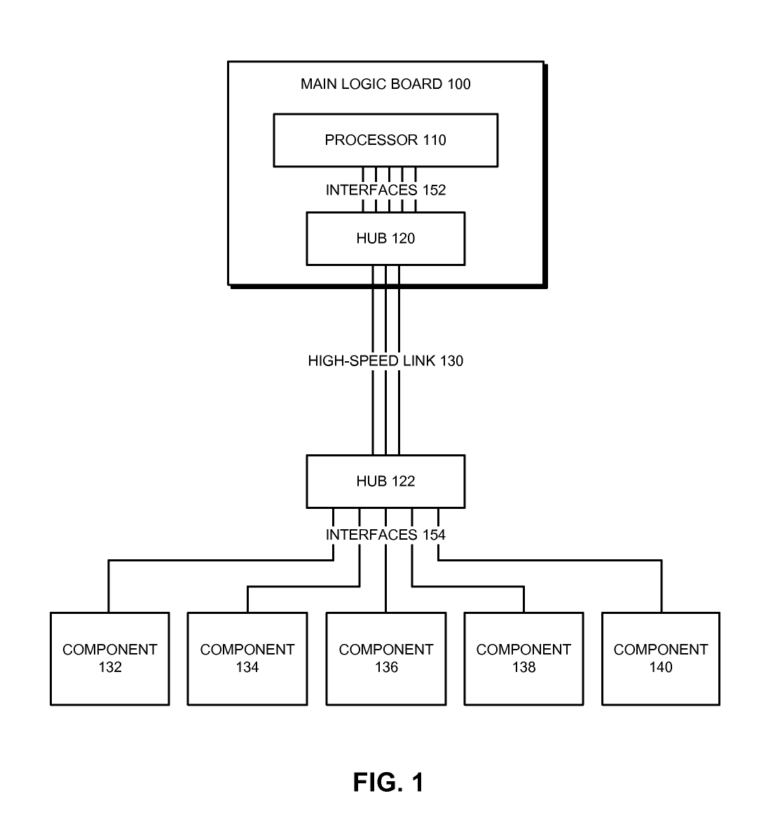

The disclosed embodiments provide a method and system for facilitating communication among a set of components. The components may be used to implement the functionality of a portable electronic device, such as a laptop computer, tablet computer, mobile phone, personal digital assistant (PDA), portable media player, and/or digital camera. As shown in FIG. 1, the components may include a processor 110 on a main logic board 100 (e.g., motherboard) in the portable electronic device. The components may also include a set of peripheral components 132-140, such as ports, buttons, wireless transceivers, speakers, and/or microphones, which communicate with the processor using a set of interfaces 152-154. For example, processor 110 and/or components 132-140 may use an Inter-Integrated Circuit (I²C) interface and/or a set of general-purpose input-output (GPIO) interfaces to transmit signals among one another. Other implementations may include a serial peripheral interface (SPI) or a secure digital input output (SDIO) interface in addition to (or place of) the I²C interface.

Those skilled in the art will appreciate that processor 110 and components 132-140 may be positioned and/or placed in a way that maximizes use of space within the portable electronic device. Such physical separation among processor 110 and components 132-140 may additionally require the use of wires to enable communication among processor 110 and components 132-140. For example, a set of wires spanning the length of a tablet computer may connect processor 110 on one end of the tablet computer to an input/output (I/O) device on the other end of the tablet computer, thus allowing processor 110 to communicate with the I/O device over an I²C interface.

However, such wires must be accommodated within the enclosure of the portable electronic device. For example, gaps between components (e.g., processor 110, components 132-140) may be created within the portable electronic device so that wires connecting the components may be placed within the gaps. Along the same lines, one or more dimensions of the portable electronic device may be increased to create space for the wires within the portable electronic device.

Moreover, increased functionality in the portable electronic device may be provided by adding new components (e.g., components 132-140) to the portable electronic device and using more wires to transmit signals among the components. Consequently, wires may take up increasing amounts of space within the portable electronic device as the portable electronic device is updated and/or improved.

In one or more embodiments, the system of FIG. 1 facilitates efficient use of space within the portable electronic device by reducing the number of wires required to transmit communications among the components (e.g., processor 110, components 132-140). A first hub 120 may connect a first set of interfaces 152 to a high-speed link 130, and a second hub 122 may connect a second set of interfaces 154 to high-speed link 130. As discussed in further detail below, hubs 120-122 and high-speed link 130 may provide an interface extender that uses a smaller number of wires and a higher operating frequency than those of interfaces 152-154 to enable communication among components in the portable electronic device (e.g., processor 110, components 132-140). Note that if there exist a number of interfaces having different speeds (e.g., I²C, SPI, SDIO and GPIO) connected to hubs 120-122, hubs 120-122 can change the speed and internal timing of high-speed link 130 dynamically to reduce power. So depending on the type of traffic high speed link 130 is receiving from the interfaces (I²C, SPI, SDIO or GPIO) high speed link 130 can change its speed. For example, if high speed link 130 receives mixed traffic from more than one interface it could choose a data rate between the hubs for the higher-speed traffic.

To facilitate communication between components in the portable electronic device, hub 120 may receive communications from processor 110 through interfaces 152 and transmit the communications over high-speed link 130 to hub 122. Once hub 122 receives the communications, hub 122 may transmit the communications through interfaces 154 to one or more components 132-140 to which the communications are directed. Conversely, hub 122 may receive communications from components 132-140 through interfaces 154 and transmit the communications over high-speed link 130 to hub 120. After receiving the communications, hub 120 may transmit the communications over interfaces 152 to processor 110.

In one or more embodiments, hubs 120-122 and high-speed link 130 reduce the amount of space occupied by wires within the portable electronic device regardless of the use of interfaces 152-154, processor 110, and/or components 132-140 in the portable electronic device. In particular, high-speed link 130 may include a clock wire that transmits a clock signal from processor 110 to components 132-140, a first data wire associated with communications from processor 110 to components 132-140, and a second data wire associated with communications from components 132-140 to processor 110. The operating frequency of high-speed link 130 may be significantly higher than the operating frequencies of interfaces 152-154, thus allowing unidirectional communications associated with multiple interfaces 152-154 to be transmitted over one data wire. For example, high-speed link 130 may operate at MHz frequencies, which is more than one order of magnitude faster than the 400 KHz operating frequency of one or more I²C interfaces coupled to hubs 120-122.

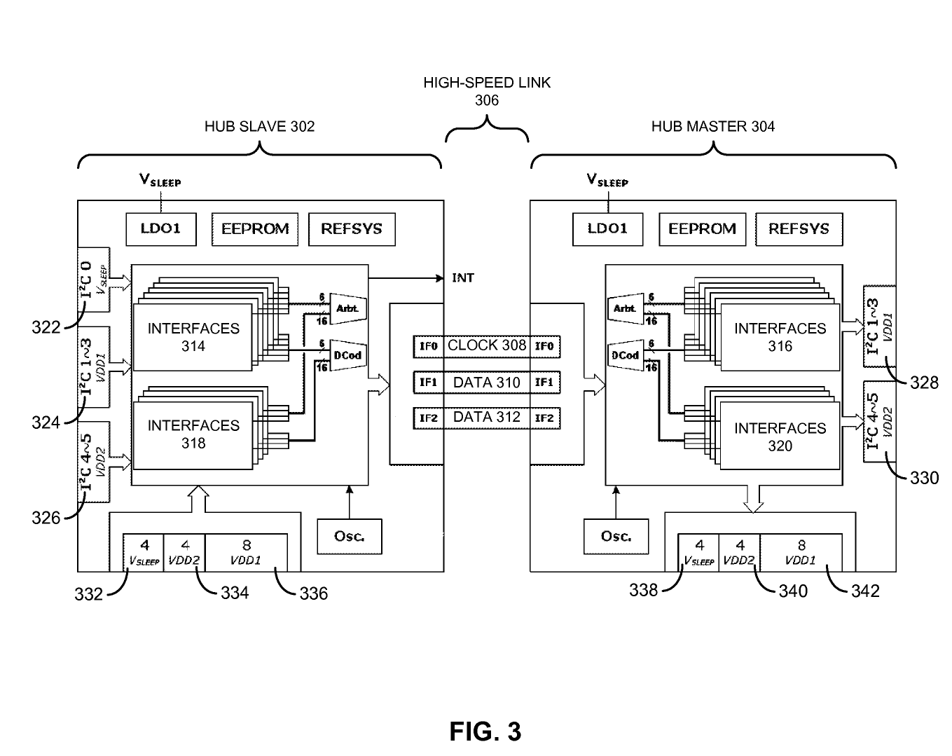

To transmit communications through high-speed link 130, hubs 120-122 may encode communications received from processor 110 and/or components 132-140. Likewise, hubs 120-122 may decode the communications after the communications are received over high-speed link 130. For example, hub 120 may process a communication from processor 110 by identifying the interface and a transition (e.g., low to high, high to low) associated with the communication, encoding the transition and the identified interface into a six-bit packet, and transmitting the packet over a unidirectional data wire in high-speed link 130 to hub 122. Hub 122 may receive the packet, decode the packet to obtain the transition and the interface, and generate the transition at the identified interface. Transmission of data over high-speed link 130 is discussed in further detail below with respect to FIG. 3.

High-speed link 130 may thus reduce the number of wires used to transmit signals between processor 110 and components 132-140 from a multiple of the number of interfaces 152-154 in the portable electronic device to three. Furthermore, because interfaces 152-154 to which the components (e.g., processor 110, components 132-140) are directly connected are not modified by hubs 120-122 and/or high-speed link 130, hubs 120-122 and high-speed link 130 may also provide a software-agnostic mechanism for facilitating communication between the components.

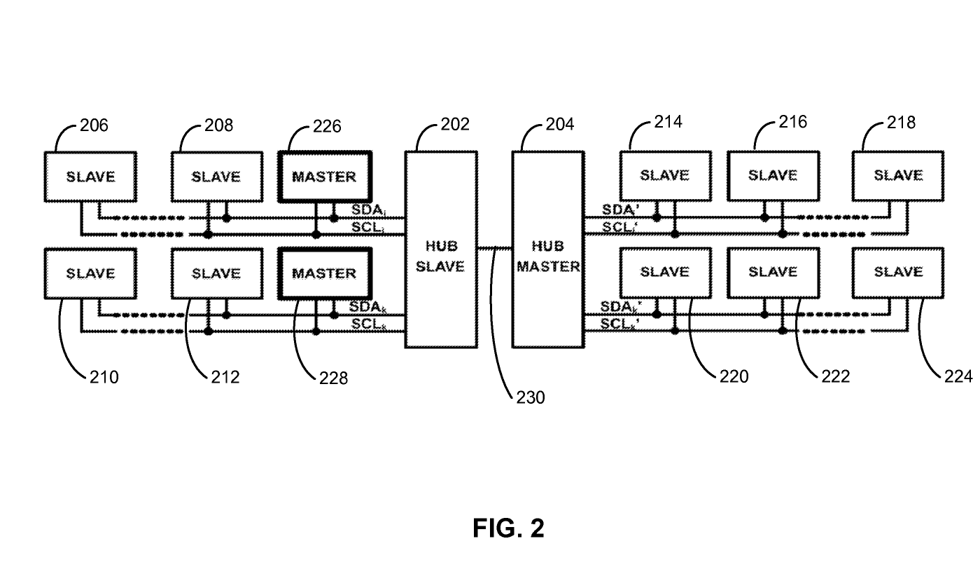

In one or more embodiments, hubs 120-122 are configured to facilitate the transmission of data between bus master components and bus slave components connected to interfaces 152-154. For example, processor 110 may correspond to an I²C master that issues a clock signal and transmits data to I²C slave components 132-140 using addresses for components 132-140. To facilitate operation of processor 110 as an I²C master, hub 120 may act as a hub slave that receives the clock signal and data from processor 110 through interfaces 152 and transmits the clock signal and data over high-speed link 130 to hub 122. Hub 120 may also receive configuration information associated with hubs 120-122 from processor 110 and propagate the configuration information to hub 122. On the other hand, hub 122 may act as a hub master that receives the clock signal and data from high-speed link 130 and issues the clock signal and data to components 132-140 over interfaces 154. The operation of hub masters and hub slaves discussed in further detail below with respect to FIG. 2.

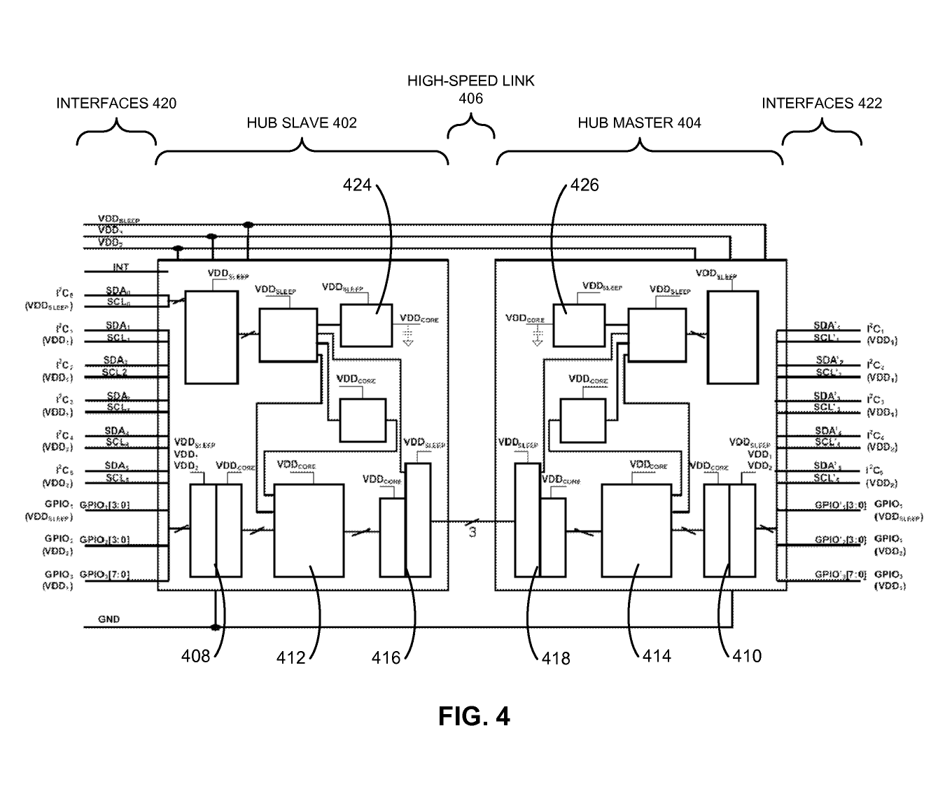

To handle communications from interfaces 152-154 with different operating voltages (e.g., 1.8 V, 3.3 V, 5.0 V), each hub 120-122 may include a first level shifter that converts a set of interface voltages from interfaces 152-154 connected to the hub to a core voltage associated with the hub. The hub may also include a second level shifter that converts the core voltage to a link voltage associated with high-speed link 130. In other words, hubs 120-122 may convert different interface voltages associated with interfaces 152-154 to a core voltage at which hubs 120-122 operate to buffer and/or encode communications received from interfaces 152-154 connected to the hubs. After the communications are encoded, the core voltage is converted to the link voltage of high-speed link 130 to enable the transmission of the encoded communications over high-speed link 130. Management of voltages by hubs 120-122 is discussed in further detail below with respect to FIG. 4.

FIG. 2 shows the connection of a hub slave 202 and a hub master 204 to a set of components 206-228 in accordance with an embodiment. As shown in FIG. 2, hub slave 202 may be connected to one or more bus master components 226-228 and a set of bus slave components 206-212, while hub master 204 may be connected to only bus slave components 214-224. For example, hub slave 202 and hub master 204 may provide an interface extender for two or more I²C interfaces (e.g., “SDAᵢ” “SDAₖ”). Hub slave 202 may be connected to one or more processors, microcontrollers, and/or systems-on-a-chip (SoCs) operating as I²C masters of the I²C interfaces, while hub master 204 may be connected to a set of peripheral components operating as I²C slaves of the I²C interfaces.

In addition, hub slave 202 and hub master 204 may be configured to facilitate communication between bus master components 226-228 and bus slave components 214-224. In particular, hub slave 202 and hub master 204 may act as slaves and masters of components 206-228 to which hub slave 202 and hub master 204 are respectively connected. For example, hub slave 202 may act as a slave device to bus master components 226-228 by receiving clock signals and/or communications from bus master components 226-228. Similarly, hub master 204 may act as a master device to bus slave components 214-224 by transmitting clock signals and/or communications received from hub slave 202 to slave components 214-224.

Hub slave 202 and hub master 204 may also enable clock stretching between a bus slave component (e.g., components 206-224) and a bus master component (e.g., components 226-228). For example, hub master 204 may detect the holding of a clock line low by bus slave component 220 during communications between bus master component 228 and bus slave component 220. Hub master 204 may transmit an encoding representing the clock stretching by bus slave component 220 to hub slave 202, which then holds a clock signal from bus master component 228 low to prevent bus master component 228 from transmitting more data. Conversely, hub slave 202 may detect clock stretching from bus slave component 206 and transmit an encoding representing the stretched clock to hub master 204, which may then propagate the stretched clock to bus slave components 214-224 to maintain uniformity in timing across all components 206-228 connected to hub slave 202 and/or hub master 204.

Furthermore, hub slave 202 may include functionality to receive configuration information from one or more bus master components 226-228 and propagate the configuration information to hub master 204. For example, hub slave 202 and hub master 204 may correspond to two hubs (e.g., hubs 120-122 of FIG. 1) containing identical circuitry. To configure the hubs as hub slave 202 and hub master 204, one or more bus master components 226-228 may transmit an active-low signal to a boot pin on the hub corresponding to hub slave 202. Bus master components 226-228 may also transmit configuration information related to the powering of hub slave 202 and hub master 204, control of GPIO interfaces, and/or other configuration-specific registers to hub slave 202. Hub slave 202 may then set one or more configuration registers based on the configuration information and propagate the configuration information over a high-speed link 230 to hub master 204, where corresponding configuration registers are also set.

Those skilled in the art will appreciate that other arrangements of components (e.g., components 206-228), hub slaves (e.g., hub slave 202), and hub masters (e.g., hub master 204) may be possible. For example, hub slave 202 and hub master 204 may include functionality to transmit communications between components 206-228 with bus master components (e.g., components 226-228) connected to both hub slave 202 and hub master 204. Hub slave 202 may also be connected to multiple hub masters to increase the number of bus slave components connected to the interface extender and/or reduce the number of wires used to transmit communications between the bus slave components and the bus master components.

FIG. 3 shows a set of wires 308-312 and a set of interfaces 314-320 associated with a hub slave 302 and a hub master 304 in accordance with an embodiment. As mentioned previously, wires 308-312 may form a high-speed link 306 that reduces the number of wires required to transmit communications between components connected to interfaces 314-320.

In particular, high-speed link 306 may include a clock wire 308 and two data wires 310-312. Clock wire 308 may be used to transmit a clock signal from a bus master component connected to hub slave 302 to bus slave components connected to hub master 304. Data wires 310-312 may correspond to unidirectional data wires that transmit communications between components connected to hub slave 302 and components connected to hub master 304. For example, communications from components connected to hub slave 302 may buffered, encoded, and transmitted at high speed over data line 310 to hub master 304 to reduce the number of wires required to transmit the communications from a first set of interfaces 314 and 318 to a second set of interfaces 316 and 320.

Interfaces 314-320 may correspond to different interfaces that are extended by hub slave 302, hub master 304, and high-speed link 306. For example, interfaces 314-316 may correspond to I²C interfaces that are connected to sets of voltage rails 322-326 and 328-330. Rail 322 may be associated with an I²C interface (e.g., “I²C0”) that is used to transmit configuration information from a bus master component to hub slave 302 at a first operating voltage (e.g., “V_{SLEEP}”). The configuration information may be used to set configuration registers in hub slave 302 and/or propagated to hub master 304 for the setting of configuration registers in hub master 304. Rails 324 and 328 may each be associated with three I²C interfaces (e.g., “I²C1˜3”) at a second operating voltage (e.g., “VDD1”), and rails 326 and 330 may each be associated with two I²C interfaces (e.g., “I²C4˜5”) at a third operating voltage (e.g., “VDD2”). Rails 322-330 330 may thus allow I²C nodes that operate at different voltages to be connected through hub slave 302, hub master 304, and high-speed link 306.

Along the same lines, interfaces 318-320 may correspond to GPIO interfaces that are also connected to multiple sets of voltage rails 332-342. Rails 332 and 338 may each be associated with four GPIO interfaces at a first operating voltage (e.g., “V_{SLEEP}”), rails 334 and 340 may each be associated with four GPIO nodes at a second operating voltage (e.g., “VDD2”), and rails 336 and 342 may each be associated with eight GPIO nodes at a third operating voltage (e.g., “VDD1”). As discussed in further detail below with respect to FIG. 4, various operating voltages associated with rails 322-342 may be converted to a core voltage associated with hub slave 302 and/or hub master 304 to enable the processing of communications from interfaces 314-320 with different interface (e.g., operating) voltages. The core voltage may then be converted to a link voltage associated with high-speed link 306 to enable the transmission of the communications across high-speed link 306.

FIG. 4 shows the use of a set of voltages in a hub slave 402 and a hub master 404 in accordance with an embodiment. A first interface (e.g., operating) voltage (e.g., “VDD_{SLEEP}”) may be used to power hub slave 402 and hub master 404 and/or transmit configuration information to hub slave 402 and/or hub master 404. A set of voltage regulators 424-426 (e.g., low-dropout regulators) may convert the first interface voltage into a core voltage (e.g., “VDD_{CORE}”) at which hub slave 402 and hub master 404 operate.

As described above, additional interface voltages (e.g., “VDD₁,” “VDD₂”) may be used to transmit communications from one or more sets of interfaces 420-422 (e.g., I²C interfaces, GPIO interfaces) to the hubs (e.g., hub slave 402, hub master 404). To enable buffering and/or processing of the communications by hub slave 402 and hub master 404, a first set of level shifters 408-410 may convert the interface voltages from interfaces 420-422 to the core voltage of hub slave 402 and hub master 404.

After the interface voltages are converted to the core voltage, interface-processing mechanisms 412-414 on the hubs may encode the communications into packets for transfer over a high-speed link 406 connecting hub slave 402 and hub master 404. Next, a second set of level shifters 416-418 may convert the core voltage into a link voltage (e.g., “VDD_{SLEEP}”) associated with high-speed link 406. The encoded communications may then be transmitted over high-speed link 406 at the link voltage. As shown in FIG. 4, the link voltage may correspond to the first interface voltage that is used to power the hubs.

Alternatively, the link voltage may correspond to an operating voltage that is different from that of the first interface voltage.

Once the encoded communications are received over high-speed link 406, a complementary level shifter 416-418 on the receiving hub (e.g., hub slave 402, hub master 404) may convert the link voltage through which the encoded communications are received into the core voltage of the receiving hub to enable decoding of the encoded communications by the corresponding interface-processing mechanism 412-414. After the communications are decoded, the core voltage is converted into a set of interface voltages by the next level shifter 408-410 to enable transmission of the decoded communications to interfaces 420-422 at the interface voltages of interfaces 420-422.

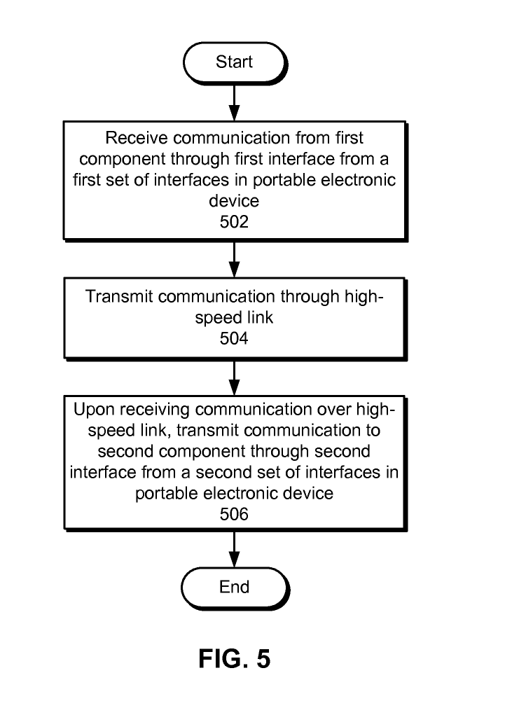

FIG. 5 shows a flowchart illustrating the process of facilitating communication between components in a portable electronic device in accordance with an embodiment. In one or more embodiments, one or more of the steps may be omitted, repeated, and/or performed in a different order. Accordingly, the specific arrangement of steps shown in FIG. 5 should not be construed as limiting the scope of the embodiments.

First, a communication is received from a first component through a first interface from a first set of interfaces in a portable electronic device (operation 502). For example, the communication may be received from a processor and/or peripheral component through an I²C interface and/or GPIO interface.

Next, the communication is transmitted through a high-speed link (operation 504). To enable transmission of the communication over the high-speed link, the communication may be encoded. For example, the first interface and a transition associated with the communication may be identified and encoded into a packet that is then transmitted on a unidirectional data wire in the high-speed link. A clock signal accompanying the transition may also be transmitted over a clock wire in the high-speed link.

Upon receiving the communication over the high-speed link, the communication is transmitted to a second component through a second interface from a second set of interfaces in the portable electronic device (operation 506). For example, the packet may be received over the high-speed link and decoded to identify the transition and the second interface. The transition may then be generated at the second interface to transmit the communication to the second component.

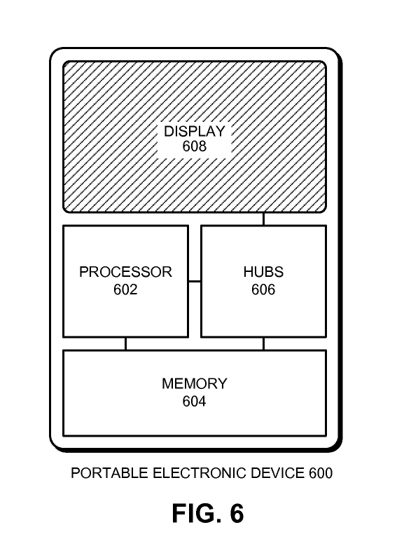

The above-described rechargeable battery cell can generally be used in any type of electronic device. For example, FIG. 6 illustrates a portable electronic device 600 which includes a processor 602, a memory 604 and a display 608. Portable electronic device 600 may correspond to a laptop computer, tablet computer, mobile phone, PDA, portable media player, digital camera, and/or other type of battery-powered electronic device. In addition, communication among processor 602, memory 604, display 608, and/or other components in portable electronic device 600 may be facilitated by a set of hubs 606.

In particular, hubs 606 may include a first hub that couples a first set of interfaces to a high-speed link and a second hub that couples a second set of interfaces to the high-speed link. The first and second sets of interfaces may include an I²C interface and/or a GPIO interface. The first hub may receive a communication from a first component through a first interface in the first set of interfaces and transmit the communication through the high-speed link. The second hub may receive the communication from the high-speed link and transmit the communication to a second component through a second interface in the second set of interfaces. The first and second hubs may thus reduce the number of wires required to transmit communications between the first and second sets of interfaces.

The foregoing descriptions of various embodiments have been presented only for purposes of illustration and description. They are not intended to be exhaustive or to limit the present invention to the forms disclosed. Accordingly, many modifications and variations will be apparent to practitioners skilled in the art. Additionally, the above disclosure is not intended to limit the present invention.

What is claimed is:

1. A system for facilitating communication between components in a portable electronic device, comprising:
a first hub that couples a first set of interfaces to a high-speed link, wherein the first hub is configured to:
receive a communication from a first component through a first interface in the first set of interfaces; and
transmit the communication through the high-speed link; and
a second hub that couples a second set of interfaces to the high-speed link, wherein the second hub is configured to:
receive the communication from the high-speed link; and
transmit the communication to a second component through a second interface in the second set of interfaces,
wherein transmitting communications between the first set of interfaces and the second set of interfaces through the high-speed link reduces a number of wires required to transmit the communications.

2. The system of claim 1,
wherein transmitting the communication through the high-speed link involves encoding the communication, and
wherein receiving the communication from the high-speed link involves decoding the communication.

3. The system of claim 2, wherein encoding the communication involves:
identifying the first interface and a transition associated with the communication; and
encoding the transition and the first interface into a packet.

4. The system of claim 1,
wherein the first hub corresponds to a hub master, and
wherein the second hub corresponds to a hub slave.

5. The system of claim 4,
wherein the hub slave is connected to one or more bus master components, and
wherein the hub master is connected to one or more bus slave components.

6. The system of claim 4, wherein the hub slave is configured to:
receive configuration information from a processor in the portable electronic device; and
propagate the configuration information to the hub master.

7. The system of claim 1, wherein the first hub comprises:
a first level shifter configured to convert a set of interface voltages from the first set of interfaces to a core voltage associated with the first hub; and
a second level shifter configured to convert the core voltage to a link voltage associated with the high-speed link.

8. The system of claim 1, wherein the high-speed link comprises:
a clock wire;
a first data wire associated with communications from the first set of interfaces to the second set of interfaces; and
a second data wire associated with communications from the second set of interfaces to the first set of interfaces.

9. The system of claim 1, wherein the first set of interfaces includes at least one of:
an Inter-Integrated Circuit (I²C) interface;
a serial peripheral interface (SPI);
a secure digital input output (SDIO) interface; and
a general-purpose input-output (GPIO) interface.

10. The system of claim 1, wherein the high-speed link is configured to change speed based on a mix of traffic the high-speed link is receiving.

11. A portable electronic device, comprising:
a first set of interfaces;
a second set of interfaces;
a first hub that couples the first set of interfaces to a high-speed link, wherein the first hub is configured to:
receive a communication from a first component through a first interface in the first set of interfaces; and
transmit the communication through the high-speed link; and
a second hub that couples the second set of interfaces to the high-speed link, wherein the second hub is configured to:
receive the communication from the high-speed link; and
transmit the communication to a second component through a second interface in the second set of interfaces,
wherein transmitting communications between the first set of interfaces and the second set of interfaces through the high-speed link reduces a number of wires required to transmit the communications.

12. The portable electronic device of claim 11,
wherein transmitting the communication through the high-speed link involves encoding the communication, and
wherein receiving the communication from the high-speed link involves decoding the communication.

13. The portable electronic device of claim 12, wherein encoding the communication involves:
identifying the first interface and a transition associated with the communication; and
encoding the transition and the first interface into a packet.

14. The portable electronic device of claim 11,
wherein the first hub corresponds to a hub master, and
wherein the second hub corresponds to a hub slave.

15. The portable electronic device of claim 14,
wherein the hub slave is connected to one or more bus master devices, and
wherein the hub master is connected to one or more bus slave devices.

16. The portable electronic device of claim 14, wherein the hub slave is configured to:
receive configuration information from a processor in the portable electronic device; and
propagate the configuration information to the hub master.

17. The portable electronic device of claim 11, wherein the first and second hubs comprise:
a first level shifter configured to convert a set of interface voltages from the first set of interfaces to a core voltage associated with the first hub; and
a second level shifter configured to convert the core voltage to a link voltage associated with the high-speed link.

18. The portable electronic device of claim 11, wherein the high-speed link comprises:
a clock wire;
a first data wire associated with communications from the first set of interfaces to the second set of interfaces; and
a second data wire associated with communications from the second set of interfaces to the first set of interfaces.

19. The portable electronic device of claim 11, wherein the high-speed link is configured to change speed based on a mix of traffic the high-speed link is receiving.

20. A method for facilitating communication between components in a portable electronic device, comprising:
receiving a communication from a first component through a first interface from a first set of interfaces in the portable electronic device;
transmitting the communication through a high-speed link; and
upon receiving the communication over the high-speed link, transmitting the communication to a second component through a second interface from a second set of interfaces in the portable electronic device,
wherein transmitting communications between the first set of interfaces and the second set of interfaces through the high-speed link reduces a number of wires required to transmit the communications.

21. The method of claim 20,
wherein transmitting the communication through the high-speed link involves encoding the communication, and
wherein receiving the communication from the high-speed link involves decoding the communication.

22. The method of claim 21, wherein encoding the communication involves:
identifying the first interface and a transition associated with the communication; and
encoding the transition and the first interface into a packet.

23. The method of claim 20, wherein the high-speed link comprises:
a clock wire;
a first data wire associated with communications from the first set of interfaces to the second set of interfaces; and
a second data wire associated with communications from the second set of interfaces to the first set of interfaces.

24. The method of claim 20, wherein the first set of interfaces includes at least one of:
an Inter-Integrated Circuit (I²C) interface;
a serial peripheral interface (SPI);
a secure digital input output (SDIO) interface; and
a general-purpose input-output (GPIO) interface.

25. The method of claim 20, wherein the portable electronic device is at least one of a mobile phone, a tablet computer, and a portable media player.
